(19) United States
(12) Patent Application Publication
(10) Pub. No.: US 2009/0144987 A1
(43) Pub. Date: Jun. 11, 2009

(54) Multi-blade cutting apparatus

(76) Inventor: Joseph Mills, Holladay, UT (US)

Correspondence Address: BRETT J. DAVIS, P. O. BOX 1909, SANDY, UT, 84091, US

(21) Appl. No.: 12/001,628

(22) Filed: Dec. 11, 2007

(51) Int. Cl. B26B 27/00; B26B 11/00; B26D 1/00

(52) U.S. Cl. 30/173; 30/312; 83/13

(57) ABSTRACT

A multi-bladed cutting apparatus for slicing objects, such as food items, into slices. The blades of the apparatus may be operable between a cutting position and a release position. In the cutting position, the blades are able to efficiently cut objects into smaller sizes. In the release position, any matter lodged between the blades falls out of its own accord. In this manner, the need for a user to manually removed matter lodged between the blades is eliminated. One or more levers responsive to an input force from a user may be utilized to move the blades from the cutting position to the release position. A flexible member may provide restoring force to return the blades to the cutting position.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Invention

The present disclosure relates generally to cutting instruments with blades, and more particularly, but not necessarily entirely, to cutting instruments with multiple blades.

2. Description of Related Art

Modern cutting instruments for cutting objects, such as food items, typically comprise a single blade extending from a handle. A user may grasp the handle to thereby control the movement of the blade and to impart cutting motions onto the blade itself. Previously available blades may be formed from a wide variety of materials, including metals and plastics. In addition, previously available handles may be formed from a wide range of materials as well, including metals, wood and plastics. Some previously available cutting instruments have blades integrally formed with the handles, such as plastic knifes and butter knifes.

One drawback to using a cutting instrument of conventional design, i.e., a single-bladed design as described above, is the inability to efficiently and quickly cut bite-sized pieces. One attempt to overcome this drawback is shown in U.S. Design Pat. No. D508,383 issued to Endres et al. on Aug. 16, 2005 (the “'383 Patent”). The '383 Patent teaches a design for a utensil for cutting food into child-sized bites. The utensil includes a plurality of blades arranged in a side-by-side arrangement. The top edge of the blades are coupled to a bottom surface of a disk-shaped body. While apparently an improvement over a conventional design, the disk-shaped body appears difficult to grasp as no clear handle is present. Further, the blades on the utensil appear to be fixed into place and do not appear to be removable or adjustable, thus the width of the slices cut by the utensil does not appear to be variable. This is disadvantageous, since often times a user may wish to increase or decrease the width of the slices.

Despite the advantages of known cutting instruments, improvements are still being sought as the previously available devices are characterized by several disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a schematic view of a cutting apparatus made in accordance with the principles of the present disclosure;

FIG. 2 is a side view of a blade for use with the cutting apparatus depicted in FIG. 1;

FIG. 3 is a cross-sectional view of the cutting apparatus taken along the section A-A shown in FIG. 1;

FIG. 4 is a side view of another embodiment of a cutting apparatus pursuant to the present disclosure;

FIG. 5 is a perspective view of a cutting apparatus pursuant to an embodiment of the present invention;

FIG. 6 is an end view of the cutting apparatus depicted in FIG. 5; and

FIG. 7 is an end view of the cutting apparatus depicted in FIG. 5 in the release position.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and grammatical equivalents thereof are inclusive or open-ended terms that do not exclude additional, unrecited elements or method steps.

Applicant has discovered a novel cutting instrument that permits a user to efficiently and quickly slice objects, such as food items, into slices and bite-sized pieces. The cutting instrument includes a plurality of blades arranged in a side-by-side arrangement. The blades may include curved cutting edges and a handle of ergonomic design to facilitate the use of a rocking cut motion. In one embodiment, the blades are selectively removable from a coupling member to thereby allow a user to vary the width of the slices cut by the device. In another embodiment, the blades are moveable between a cutting position and a release position.

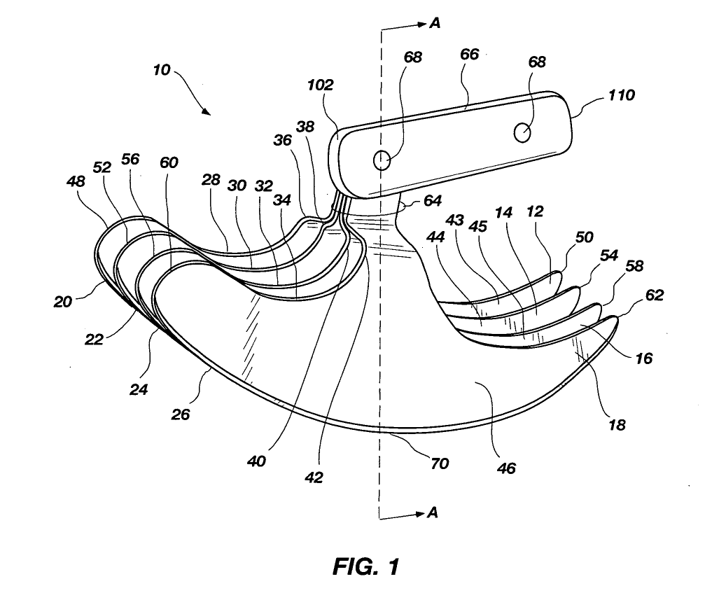

Referring now to FIG. 1, there is an apparatus 10 for cutting an object into slices. The apparatus 10 is particularly adapted for cutting and slicing food items into bite-sized pieces in just two cutting actions. The apparatus 10 includes a plurality of blades 12, 14, 16 and 18 that are arranged in a side-by-side cutting arrangement. Each of the blades 12, 14, 16 and 18 is separated from adjacent blades by a gap in the side-by-side cutting arrangement.

Referring now to blade 12, blade 12 comprises a cutting edge 20 on its lowermost portion. The cutting edge 20 may be sharpened to any desired sharpness, including in the range from dull to extremely sharp, depending upon the intended use of the apparatus 10. For example, the sharpness of the cutting edge 20 may be varied for safety purposes in the event that the apparatus 10 may be used by children or the cutting edge 20 may be extremely sharp if the intended use of the apparatus 10 is for cutting meat. The blade 12 may include a top edge 28 opposite from the cutting edge 20. Interposed between the top edge 28 and the cutting edge 20 is a body portion 43. The body portion 43 may be solid and rigid such that the blade 12 does not bend or deform while the apparatus 10 is in use. The blade 12 may further include a first end 48 and a second end 50. The top edge 28 and the cutting edge 20 may intersect at the first end 48 and the second end 50. Extending from the top edge 28 of the blade 12 is a shanked portion 36 whose purpose and function will be explained hereinafter.

Referring now to blade 14, blade 14 also comprises a cutting edge 22 on its lowermost portion. The cutting edge 22 may be sharpened to any desired sharpness, including in the range from dull to extremely sharp, depending upon the intended use of the apparatus 10. For example, the sharpness of the cutting edge 22 may be varied for safety purposes in the event that the apparatus 10 may be used by children or the cutting edge 22 may be extremely sharp if the intended use of the apparatus 10 is for cutting meat. The blade 14 may include a top edge 30 opposite from the cutting edge 22. Interposed between the top edge 30 and the cutting edge 22 is a body portion 44. The body portion 44 may be solid and rigid such that the blade 14 does not bend or deform while the apparatus 10 is in use. The blade 14 may further include a first end 52 and a second end 54. The top edge 30 and the cutting edge 22 may intersect at the first end 52 and the second end 54. Extending from the top edge 30 of the blade 14 is a shanked portion 38 whose purpose and function will be explained hereinafter.

Referring now to blade 16, blade 16 also comprises a cutting edge 24 on its lowermost portion. The cutting edge 24 may be sharpened to any desired sharpness, including in the range from dull to extremely sharp, depending upon the intended use of the apparatus 10. For example, the sharpness of the cutting edge 24 may be varied for safety purposes in the event that the apparatus 10 may be used by children or the cutting edge 24 may be extremely sharp if the intended use of the apparatus 10 is for cutting meat. The blade 16 may include a top edge 32 opposite from the cutting edge 24. Interposed between the top edge 32 and the cutting edge 24 is a body portion 45. The body portion 45 may be solid and rigid such that the blade 16 does not bend or deform while the apparatus 10 is in use. The blade 16 may further include a first end 56 and a second end 58. The top edge 32 and the cutting edge 24 may intersect at the first end 56 and the second end 58. Extending from the top edge 32 of the blade 16 is a shanked portion 40 whose purpose and function will be explained hereinafter.

Referring now to blade 18, blade 18 also comprises a cutting edge 26 on its lowermost portion. The cutting edge 26 may be sharpened to any desired sharpness, including in the range from dull to extremely sharp, depending upon the intended use of the apparatus 10. For example, the sharpness of the cutting edge 26 may be varied for safety purposes in the event that the apparatus 10 may be used by children or the cutting edge 26 may be extremely sharp if the intended use of the apparatus 10 is for cutting meat. The blade 18 may include a top edge 34 opposite from the cutting edge 26. Interposed between the top edge 34 and the cutting edge 26 is a body portion 46. The body portion 46 may be solid and rigid such that the blade 18 does not bend or deform while the apparatus 10 is in use. The blade 18 may further include a first end 60 and a second end 62. The top edge 34 and the cutting edge 26 may intersect at the first end 60 and the second end 62. Extending from the top edge 34 of the blade 18 is a shanked portion 42 whose purpose and function will be explained hereinafter.

As can be seen in FIG. 1, the shanked portions 36, 38, 40, and 42 all converge at and pass through a common neck 64 where they are coupled together by a coupling member 66. In particular, the coupling member 66 may include fasteners 68 that extend into the coupling member 66 and through bores in the shanked portions 36, 38, 40, and 42. At least one of the fasteners 68 may be removable from the coupling member 66 to thereby allow the blades 12, 14, 16 and 18 to be selectively removed from the coupling member 66. In one embodiment, the fasteners 68 comprise male threaded shafts that engage a nut or a female threaded shaft to thereby secure the blades 12, 14, 16, and 18 to the coupling member 66. The coupling member 66 may also serve as a handle to thereby allow a user to grasp, hold, and cut using the apparatus 10. It will be understood that the fasteners 68 may comprise any type of fastener, including screws, bolts, nuts, couplers, and the like. In one alternative embodiment, the coupling member 66 permanently couples the shanked portions 36, 38, 40 and 42 together. This may be done by welding, bonding, or any other manner. The coupling member 66 may be integrally formed with the shanked portions 36, 38, 40, and 42, that is, they are all formed from a single material whether poured or molded.

It will be appreciated by those having ordinary skill in the art that the blades 12, 14, 16 and 18 may be formed from plastic or metal depending upon the intended use of the apparatus 10. Plastic may be desirable due to its low cost and ease of manufacture. However, metal may be utilized if the strength of the blades 12, 14, 16, and 18 is at issue. For example, plastic may be utilized to form the blades 12, 14, 16 and 18 if the apparatus 10 is only intended to cut soft items, such as toast or dough. If, on the other hand, the blades 12, 14, 16 and 18 are intended to cut tough or fibrous items, such as meat or vegetables, metal may be required to form the blades 12, 14, 16 and 18. The blades 12, 14, 16 and 18 may be formed of other materials, such as ceramic, although less desirable.

As can be observed in FIG. 1, the apparatus 10 is depicted with four (4) blades, namely blades 12, 14, 16 and 18. It will be understood that the number of blades shown in FIG. 1 is not limiting on the present disclosure as the applicant's invention may comprise more or less blades than four (4). For example, in one embodiment of the present disclosure, an apparatus for cutting may comprise five (5) blades. In another embodiment of the present disclosure, the apparatus may comprise three (3) blades. Thus, it will be understood that an apparatus in accordance with the applicant's invention may include a plurality of blades.

Describing now the shape of the cutting edge 26 of the blade 18, it will be understood that the description of the cutting edge 26 of blade 18 is likewise applicable to the shapes of the cutting edges 20, 22, 24 of blades 12, 14, and 16, respectively. As observed in FIG. 1, when the blade 18 is observed from its side, the cutting edge 26 has a curvature, i.e., the cutting edge is not flat as the cutting edge 26 deviates upwards from a center portion 70 of the cutting edge 26 as it approaches the first end 60 and the second end 62 of the blade 18. The curved nature of the cutting edge 26 allows the apparatus 10 to be utilized with a rocking cut motion. In a rocking cut motion, one of the first end 60 or the second end 62 of the blade 18 is placed on the item to be cut. The user then rocks the blade 18 forwards or backwards, as the case may be, rocking the cutting edge 26 of the blade 18 onto the item to be cut. This “rocking motion” may be repeated several times until the cut is accomplished. Because the cutting edges 20, 22, and 24 are all shaped similarly to the cutting edge 26, it will be understood that all of the cutting edges 20, 22, 24 and 26 will cut and slice most efficiently when they are rocked back and forth on the item to be cut.

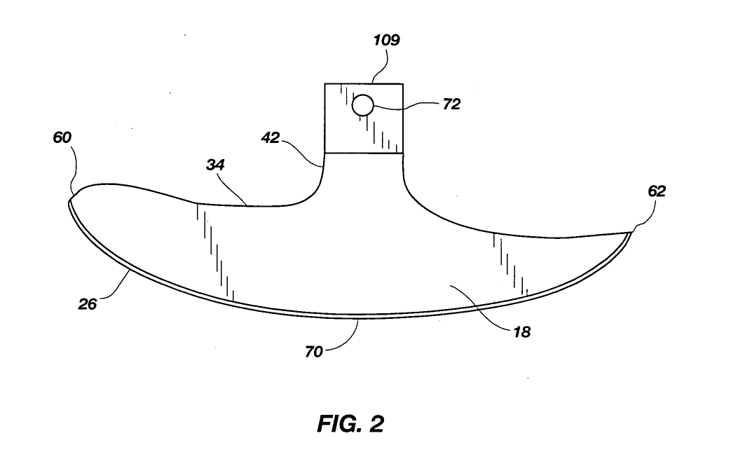

Referring now to FIG. 2, there is depicted a side view of the blade 18. The shanked portion 42 of the blade 18 extends upwardly from the top edge 34 of the blade 18 and approximately the mid-portion of the top edge 34. Located near a terminal end 109 of the shanked portion 42 of the blade 18 is a mounting hole 72. It will be understood that the shanked portions 36, 38, and 40 of blades 12, 14, and 16, respectively, may each include a mounting hole similar to mounting hole 72. As will be discussed below, the mounting hole 72 facilitates securing the blade 18 to the coupling member 66.

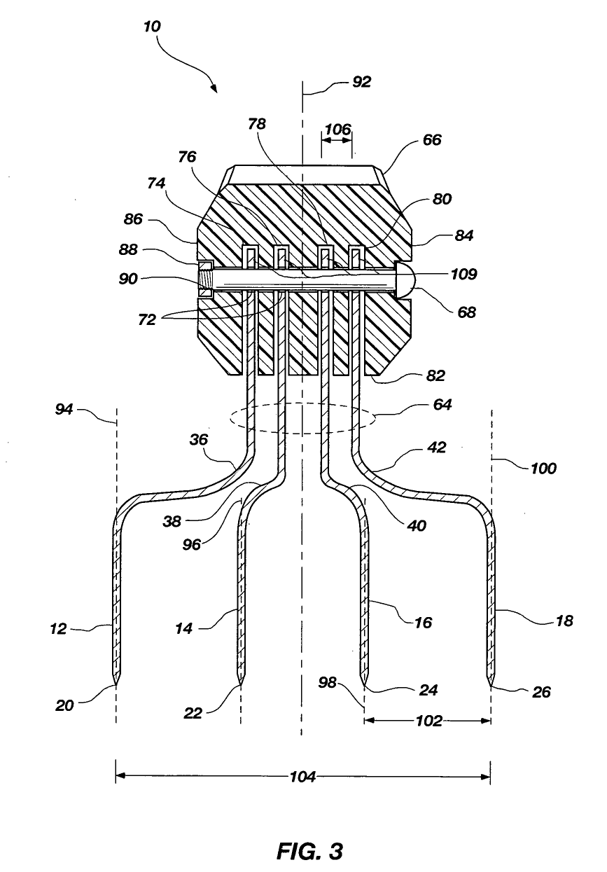

Referring now to FIG. 3, there is depicted a cross-sectional view of the apparatus 10 taken along the section A-A shown in FIG. 1. The blades 12, 14, 16 and 18 reside generally below the coupling member 66. The coupling member 66 includes rectangular slots 74, 76, 78 and 80 that extend upwardly from a lower surface 82 of the coupling member 66. The shanked portions 36, 38, 40 and 42 of the blades 12, 14, 16 and 19, respectively, extend into slots 74, 76, 78 and 80, respectively, from the lower surface 82 of the coupling member 66. The fastener 68 extends from a side surface 84 of the coupling member 66 and through the mounting holes 72 in each of the blades 12, 14, 16 and 18 to a side surface 86 of the coupling member 66. A nut 88 is secured to a threaded end 90 of the fastener 68. In this manner, the blades 12, 14, 16 and 18 are secured to the coupling member 66. Recesses may be provided in the side surfaces 84 and 86 into which a head of the fastener 68 and the nut 88 are mounted, respectively.

It will be appreciated that other types of fasteners may be utilized in lieu of fastener 68 to secure the blades 12, 14, 16 and 18. For example, a “quick release” type fastener may be used (not shown in the figures). One form of a quick-release type fastener suitable for use with the present invention includes a lever connected to one end of a rod. The rod is passed through the coupling member 66 and the mounting holes 72 in the blades 12, 14, 16 and 18 with the lever in an open position. Secured to the free end of the rod is a fastener that threadably engages the rod. The fastener is finger tightened onto the rod until it engages the coupling member 66. The lever is then closed to further tighten the quick release and hence the engagement of the blades 12, 14, 16 and 18 and the coupling member 66. Another type of fastener suitable for securing the blades 12, 14, 16 and 18 includes a spring activated catch that engages the mounting holes 72 as the terminal ends 109 of the blades 12, 14, 16 and 18 are inserted into the coupling member 66. That is, the blades 12, 14, 16 and 18 click into place via the catch as the blades are inserted into the slots 74, 76, 78, and 80 of the coupling member 66. A lever or other suitable means may be utilized to withdraw the spring loaded catch (not shown in the figures) such that the blades 12, 14, 16, and 18 can be released when desired. Another type of fastener suitable for securing the blades 12, 14, 16 and 18 includes a twist lock mechanism (not shown in the figures). The twist lock mechanism may include a twist ring that, when rotated, includes catches that engage the mounting holes 72 (or slots on the blades 12, 14, 16 and 18). To release the blades 12, 14, 16 and 18, the twist ring may be rotated in the opposite direction from the engagement direction.

Passing though the center of the coupling member 66 is a central plane 92. The blades 12 and 14 are located on one side of the central place 92 and blades 16 and 18 are located on the opposite side of the central plane 92. It will be noted that the shanked portions 36 and 38 of the blades 12 and 14, respectively, extend inwardly towards the central plane 92. Likewise, the shanked portions 40 and 42 of the blades 14 and 16, respectively, extend inwardly towards the central plane 92. Each of the shanked portions 36, 38, 40, and 42 can therefore be said to comprise a lateral component, since each of the shanked portions 36, 38, 40, and 42 extends inwardly towards the central plane 92 when the apparatus 10 is oriented as shown in FIG. 3. Further, each of the shanked portions 36, 38, 40, and 42 can also be said to comprise a vertical component, since each of the shanked portions 36, 38, 40, and 42 extends upwardly towards the coupling member 66 when the apparatus 10 is oriented as shown in FIG. 3. It will further be noted that the terminal ends 109 of the shanked portions 36, 38, 40 and 42, i.e., those portions of the shanks that extend into the slots 74, 76, 78, and 80, are parallel to the central plane 66. As can be seen in FIG. 3, each of the blades 12, 14, 16 and 18 comprises a cutting plane 94, 96, 98, and 100, respectively. The cutting planes 94, 96, 98 and 100 are all parallel to the central plane 92. It will be noted that the shanked portions 36, 38, 40 and 42 each diverges from their respective cutting planes 94, 96, 98, 100 towards the central plane 92.

While in the arrangement depicted in FIG. 3, each of the blades 12, 14, 16 and 18 are all separated from directly adjacent blades by a gap. The widths of these gaps are all equal and are generally represented by the double arrow indicated with reference numeral 102. It will be noted that the terminal ends 109 of the shanked portions 36, 38, 40 and 42 are also separated by a gap. The widths of these gaps are all equal and are generally represented by the double arrow indicated with reference numeral 106. It will be noted that the width of the gaps between the blades 12, 14, 16 and 18 are wider than the gaps of their respective shanked portions 36, 38, 40 and 42. In one embodiment, the width 102 is in the range from approximately one-half inch to approximately three inches. The blades 12 and 18 should be recognized as the outermost blades of the apparatus 10. The blades 12 and 18 are separated by a distance indicated by the double arrows marked with the reference numeral 104. In one embodiment, the distance 104 is in the range from approximately one and one-half inches to approximately nine inches.

It will be noted that any of the blades 12, 14, 16 and 18 may be removed from the coupling member 66. For example, to increase the width of the slices cut by the apparatus 10, the two innermost blades, 14 and 16, may be selectively removed from the coupling member 66. Alternatively, all but one of the blades 12, 14, 16 and 18 may be removed from the apparatus 10 such that only a single cutting edge is present. The inner blades 14 and 16 may also be placed in the outer slots 74 and 80. In this manner, the apparatus 10 includes multiple configurations as the blades 12, 14, 16 and 18 may be selectively removed from the apparatus 10. This selective feature widens the utility of the apparatus 10.

Referring back to FIG. 1, in use, a user grasps the coupling member 66 as a handle such that a free end 110 of the coupling member 66 extends away from the user's wrist, body and hand. That is, the free end 110 extends through the space between the user's index finger and thumb while an attached end 102 of the coupling member 102 is positioned near a user's pinky finger and wrist. This method of grasping and holding the coupling member 66 permits easy cutting using a rocking cut as the user rolls his or her wrist forward. The first ends 48, 52, 56, and 60 of the blades 12, 14, 16 and 18, respectively, are rounded and dulled to thereby prevent injury to a user's wrist or arm. The second ends 50, 54, 58 and 62 of the blades 12, 14, 16 and 18 may be relatively sharper that the first ends 48, 42, 56 and 60 since they are more likely not to come into contact with a user's wrist or arm. It will be noted that the coupling member 66, when used as a handle, is cantilevered as shown in FIG. 1. That is, the free end 110 of the coupling member 66 is unsupported.

It will be noted that the design of the blades 12, 14, 16 and 18 may be varied, including their width, height, composition, and sharpness. In addition, although only four (4) blades are shown depicted in relation to apparatus 10, any number of blades may be employed as discussed above. Further, striations (not shown in the figures) may be included on the blades 12, 14, 16 and 18.

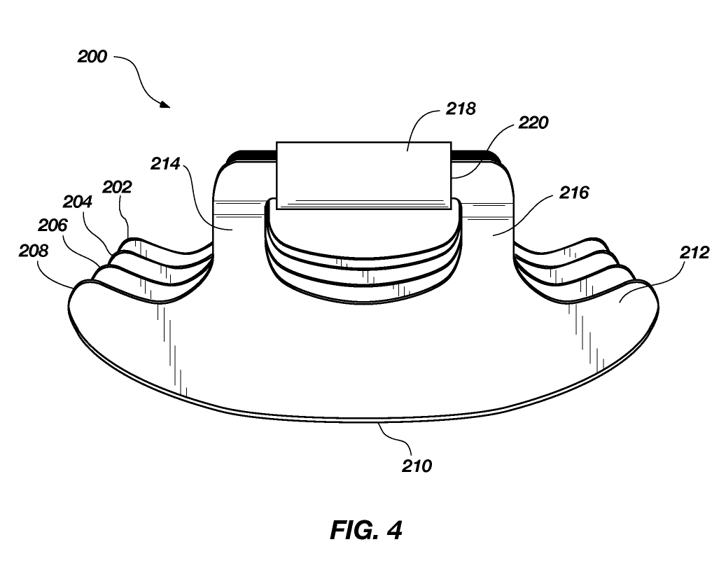

Referring now to FIG. 4, there is depicted another embodiment of an apparatus pursuant to the present disclosure indicated generally by reference numeral 200. The apparatus 200 includes blades 202, 204, 206, and 208 that are positioned in a side-by-side cutting arrangement. The blades 202, 204, 206, and 208 may be separated from any adjacent blades by a gap. Referring now to blade 208, with the understanding that blades 202, 204 and 206 have similar features, blade 208 comprises a cutting edge 210 on its lowermost portion and a top edge 212 opposite the cutting edge 210. Extending upwardly from the top edge 212 are a pair of shanked portions 214 and 216. Extending between the shanked portions 214 and 216 of the blade 208 is a cross-piece member 220. The cutting edge 210 may have a curvature to thereby allow a rocking cut motion as explained above. In another embodiment, the cutting edge 210 may have no curvature or limited curvature.

The blades 202, 204, 206 and 208 may be fixed in the side-by-side arrangement by a coupling member 218. The coupling member 218 may engage the cross-piece members of each of the blades 202, 204, 206 and 208 via slots, similar to coupling member 66 (see FIG. 3). Again, a wide variety of fasteners, some of which have been previously described, may be used to fixidly secure the blades 202, 204, 206 and 208 to the coupling member 218. In one embodiment, the fastener comprises a pair of bolts with nuts. The shanked portions of each of the blades 202, 204, 206 and 208, may diverge from their respective cutting planes towards a central plane of the apparatus 200 such that each of the shanked portions comprises a lateral component.

It should be noted that the blades 202, 204, 206, and 208 and the coupling member 218 may be integrally formed as a single component or as separate components. Again, any suitable materials may be utilized, including metal and plastic, for the components. In addition, the coupling member 218 may serve as a handle to thereby allow a user to grasp the apparatus 10 with his or her hand. Any of the blades 202, 204, 206, and 208 may be selectively removable from the coupling member 218 to thereby provide different gaps between the blades.

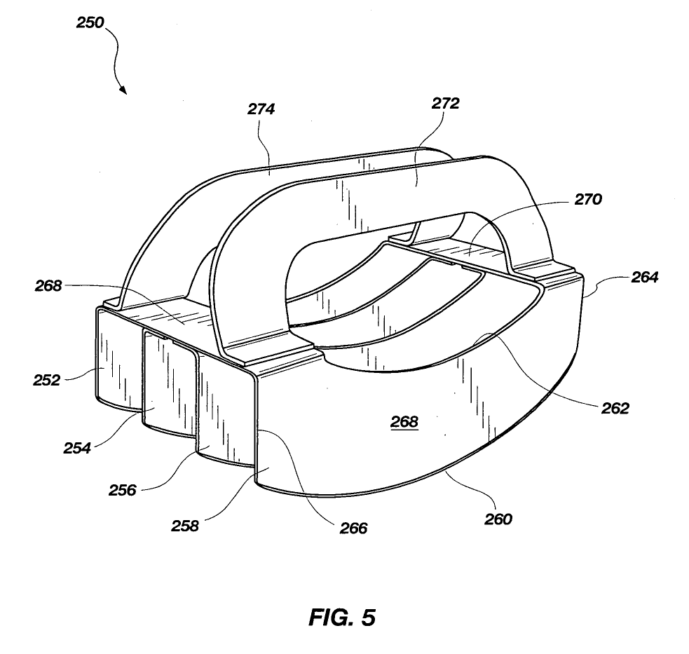

Referring now to FIG. 5, there is depicted a perspective view of an apparatus 250. The apparatus 250 comprises blades 252, 254, 256 and 258, all disposed in a side-by-side and cutting arrangement. In the cutting arrangement, the blades 252, 254, 256 and 258 are substantially parallel to each other and evenly spaced and gaps are formed between adjacent blades.

Referring now to the shape of blade 258, with the understanding that the same description equally applies to the shape of the blades 252, 254 and 256, the blade 258 comprises a cutting edge 260, a top edge 262, an end edge 264, and an end edge 266. The blade 258 further comprises a body portion 268. The cutting edge 260 may have a curvature to thereby allow a rocking cut motion as explained above. The cutting edge 260 may be sharpened to any desired level of sharpness, including from dull to extremely sharp.

The top edge 262 of the blade 258 may comprise a middle portion having a curvature that is similar to the curvature of the cutting edge 260. The outermost end portions of top edge 262 of the blade 258, which are disposed on either side of the curved middle portion, may comprise a non-curved portion. Each of the end edges 264 and 266 extend downward from the top edge 262 of the blade 258 to the cutting edge 260 of the blade 258.

Each of the blades 252, 254, 256, and 258 may extend downwardly from a pair of spaced apart cross-piece members 268 and 270. The cross-piece members 268 and 270 may extend orthogonally with respect to the blades 252, 254, 256 and 258. The blades 252, 254, 256 and 258 may be attached to the cross-piece members 268 and 270 at the non-curved portions of their respective top edges. It will be appreciated that the cross-piece members 268 and 270 may be formed from a flexible and resilient material, including the materials of metal and plastic.

Extending upwardly from the cross-piece members 268 and 270 are a pair of handles 272 and 274. In particular, each end of the handles 272 and 274 is connected to one of the cross-piece members 268 and 270 such that the handles 272 and 274 bridge between the two cross-piece members 268 and 270. The lateral spacing between the handles 272 and 274 may be limited such that a user may grasp the handles 272 and 274 at the same time with a single hand.

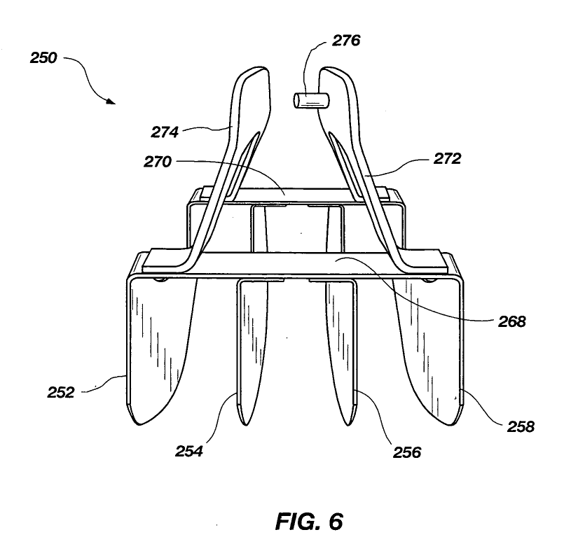

Referring now to FIG. 6, there is depicted an end view of the apparatus 250 in the cutting arrangement. As can be observed, the blades 252, 254, 256, and 258 are substantially parallel and gaps are formed between adjacent blades. The size of the gaps between adjacent blades may range from about one-quarter of an inch to about three inches. The blades 252, 254, 256, and 258 extend downwardly from each of the cross-piece members 268 and 270.

As can be observed, each of the handles 272 and 274 extends inwardly and upwardly from their respective points of attachments to the cross-piece members 268 and 270 such that the topmost portions of the handles 272 and 274 are located closer together than their points of attachments. This feature facilitates a user grasping the handles with one hand. Extending inwardly from the handle 272 is a stop 276 whose purpose and functionality will be explained below.

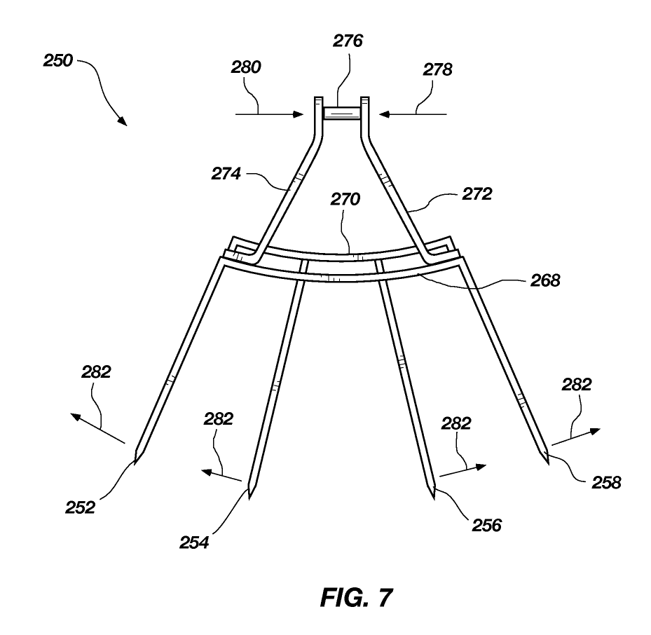

Referring now to FIG. 7, there is depicted the apparatus 250 in a release position. The release position is created when a user applies an input force to the handles 272 and 274. The user typically applies the input force in the direction of the arrows indicated by the reference numerals 278 and 280 by squeezing the handles 272 and 274 together while grasping them in the palm of one hand. When the input force is applied, the handles 272 and 274, acting as levers, cause the cross-piece members 268 and 270 to flex or bow slightly upwards in the manner shown in FIG. 7. The flexing or bowing of the cross-piece members 268 and 270 results in the gaps between adjacent blades of blades 252, 254, 256 and 258 to increase or widen as shown by the arrows indicated with the reference numeral 282. When the user ceases to apply the input force to the handles 272 and 274, the resilient nature of the cross-piece members 268 and 270 causes them, and the blades 252, 254, 256 and 258, to return to the cutting arrangement.

The benefits of the above-described features will now be enumerated. When the apparatus 250 is utilized to cut objects, such as food matter, pieces of the objects may become lodged in the gaps between the blades 252, 254, 256, and 258. It is undesirable and time consuming to require a user to manually removed the pieces lodged between the blades 252, 254, 256 and 258 after each cut. Further, it may be hazardous to the user since the blades 252, 254, 256 and 258 may cut the user's fingers while the user is attempting to remove the lodged pieces. With the present invention, after a cut, the user only need to apply the input force to the handles 272 and 274, which act as levers to cause the cross-piece members 268 and 270 to flex or bow. This flexing of the cross-piece members 268 and 270, in turn, causes the gaps between the blades 252, 254, 256 and 258 to slightly increase or widen. In this manner, the lodged pieces will typically and desirably become dislodged from between the blades and fall, on their own accord, to the cutting surface. The user may also tap the apparatus 250 onto the cutting surface to facilitate the removal of the lodged pieces.

It will be appreciated that the apparatus 250 includes at least one lever for causing the gaps between the blades 252, 254, 256, and 258 to increase or widen. It will further be appreciated that the apparatus 250 may be modified to include a plurality of blades, including at least two blades, at least three blades, or at least four blades. The apparatus 250 may be formed from any suitable material, including metal and plastic. Further, as used herein, the term “lever” means any device that applies a mechanical force to cause the blades to separate from the cutting position to a release position. The lever may be disposed in any location on a cutting apparatus made in accordance with the principles of the present invention.

Those having ordinary skill in the relevant art will appreciate the advantages provided by the features of the present disclosure. For example, it is a feature of the present disclosure to provide a multi-bladed cutting apparatus. Another feature of the present disclosure is to provide such a cutting apparatus capable of using a rocking cut motion to slice food items. It is a further feature of the present disclosure, in accordance with one aspect thereof, to provide a cutting apparatus with blades that are selectively removable to thereby vary the width of the slices cut by the apparatus.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, number of blades, form, function and manner of operation, assembly and use may be made without departing from the principles and concepts set forth herein.

What is claimed is:

1. A cutting apparatus comprising:
a plurality of blades arranged in a side-by-side arrangement such that each of the blades is separated from adjacent blades by a gap; and
at least one lever operable to increase the gaps between adjacent blades in response to an input force to thereby release any matter lodged between the blades.

2. The cutting apparatus of claim 1 wherein the plurality of blades comprises at least one of two blades and three blades.

3. The cutting apparatus of claim 1 wherein the plurality of blades comprises at least four blades.

4. The cutting apparatus of claim 1 wherein said at least one lever comprises a handhold to thereby provide a grip for a user.

5. The cutting apparatus of claim 4, wherein the at least one lever comprises two levers.

6. The cutting apparatus of claim 1, wherein the at least one lever comprises two levers.

7. The cutting apparatus of claim 1, wherein each of the plurality of blades extends downwardly from a cross-piece member.

8. A cutting apparatus comprising:
a flexible member;
a plurality of blades extending from the flexible member, the plurality of blades arranged in a side-by-side arrangement such that each of the blades is separated from adjacent blades by a gap;
at least one lever linked to the flexible member, said at least one lever operable to flex the flexible member in response to an input force; and
wherein a size of at least one of the gaps between adjacent blades is varied when said flexible member is flexed to thereby release any matter lodged between adjacent blades.

9. The cutting apparatus of claim 8, wherein said at least one lever comprises a handhold to thereby provide a grip for a user.

10. The cutting apparatus of claim 8, wherein said at least one lever comprises two spaced apart levers.

11. The cutting apparatus of claim 10, wherein each of the two spaced apart levers comprises a handhold to thereby provide a grip for a user.

12. The cutting apparatus of claim 10, wherein the two spaced apart levers are squeezable by a single hand of a user to thereby cause the flexible member to flex.

13. The cutting apparatus of claim 8 wherein the plurality of blades comprises at least three blades.

14. The cutting apparatus of claim 8 wherein the plurality of blades comprises at least four blades.

15. A method for cutting matter into smaller sizes, said method comprising the steps of:
providing a cutting apparatus, said cutting apparatus having a plurality of blades arranged in a cutting position and at least one lever operable to move the plurality of blades to a release position in response to an input force from a user;
placing the plurality of blades onto the matter and applying a cutting motion to thereby cut the matter;
applying an input force to the at least one lever to thereby release any matter lodged between the plurality of blades.

16. The method of claim 15, wherein said at least one lever comprises a handhold to thereby provide a grip for a user.

17. The method of claim 15, wherein said at least one lever comprises two spaced apart levers.

18. The method of claim 15 further comprising the step of removing the input force from the at least one lever such that the plurality of blades returns to the cutting position.

19. The method of claim 15 wherein the plurality of blades comprises at least three blades.

20. The method of claim 15 wherein the plurality of blades comprises at least four blades.

21. A cutting apparatus comprising:
a plurality of blades arranged in a side-by-side arrangement such that each of the blades is separated from adjacent blades by a gap;
each of the blades have a cutting edge and a top edge, the cutting edge of each of the blades having a curvature, and each of the top edges of the blades having a middle portion and two outermost portions which are disposed on opposite sides of the middle portion;
each of the middle portions of each of the blades having a curvature and each of the outermost portions of the top edges of each of the blades having relatively no curvature;
a pair of spaced apart cross-piece members, each of the cross-piece members comprised of a flexible and resilient material;
each of the outermost portions of the top edges of each of the blades attached to one of the cross-piece members;
a pair of handles having a first end and a second end; the first end of each of the handles attached to one of the cross-piece members and the second end of each of the handles attached to the other cross-piece member such that each of the handles bridges between the cross-piece members; and
wherein the handles may be squeezed together to thereby flex the cross-piece members to thereby increase or widen the gaps between the plurality of blades such that any matter lodged between the blades is dislodged.
